(19) United States
(12) Patent Application Publication
(10) Pub. No.: US 2026/0268812 A1
(43) Pub. Date: Sep. 10, 2026

(54) EXTENDABLE SAFETY APPARATUS FOR WARNING FUNCTION

(71) Applicants: Kamie Leone Peterson, Mapleton, UT (US); Justin Daniel Peterson, Mapleton, UT (US); Matthew Hawkes, South Jordan, UT (US)

(72) Inventors: Kamie Leone Peterson, Mapleton, UT (US); Justin Daniel Peterson, Mapleton, UT (US); Matthew Hawkes, South Jordan, UT (US)

(21) Appl. No.: 19/170,682

(22) Filed: Apr. 4, 2025

Related U.S. Application Data
(60) Provisional application No. 63/766,586, filed on Mar. 4, 2025.

(51) Int. Cl. G09F 17/00

(52) U.S. Cl. CPC G09F 17/00; G09F 2017/0025; G09F 2017/0033; G09F 2017/0075; G09F 2017/0083

(57) ABSTRACT

An extendable warning flag automated to mechanically extend upon activation by a user, the warning flag affixed to a hull of boat, ATV or recreational vehicle, including exemplarly as part of surf wake system. The system/appartus may include a flag housed within articulating or telescoping components operably to an actuator mounted within the watercraft and operably coupled to apparatus system allowing an operator to control the actuator and selectively extend the flag.

### BACKGROUND OF THE INVENTION

### Field of the Invention

This invention relates to safety, and more particularly relates to an apparatus and system for automated extension of a warning flag on recreational vehicles and/or boats engaged in recreational activities such as skiing and surfing.

### Description of the Related Art

Recreational activities such as fourwheeling, riding dune buggies, and water skiing are examples of vehicular pastimes which have long been a favored by populations enjoying the outdoors. Wake surfing has become increasingly popular in recent years and has replaced waterskiing to some extent. Boats are used to tow water-sports participants, such as water skiers, wakeboarders, and the like, using a towline. Individuals in the boat hold onto one end of the towline and the other end is attached to the boat. The water-sports participant is located aft of the boat. Individuals riding ATVs, dune buggies, and dirtbikes comb trails in mountainous terrains.

Generally, wake surfing is a water sport in which a surfer trails behind a ballasted wake boat at relatively slow speeds. Riders surf on an endless wave. Like many other recreational vehicles, wake boats are outfitting with specific hardware tailored for certain activities. For instance, rear platforms and direct submerged drives operate so that the propeller is recessed under the boat.

As a matter of safety, boaters and others engaged in vehicular activities indicate a danger with flags. In boating, when a water-sports participant has fallen and is isolated in the water, a warnging flag is raised which is typically orange. These flags are held or waived by individuals in the boat to indicate to other boaters to beware to avoid the area and look for floating participants.

However, individuals in boats and ATVs may tire of holding the flag and the flags often become lost. Individuals become distracted, and forget to hold the flag up, creating danger to individuals floating in the water or elsewhere.

There is a need in the art for a device which overcomes these inefficiencies. In light of the foregoing, it would therefore be useful to provide an automated system for extending a flag on recreational vehicle.

### SUMMARY OF THE INVENTION

From the foregoing discussion, it should be apparent that a need exists for an extending safety apparatus for boat flaggin function. Beneficially, such an apparatus would overcome many of the difficulties with prior art by providing an extendable warning flag automated to mechanically extend upon activation by a user, the warning flag affixed to a hull of boat as part of surf wake system. The system/appartus may include a flag housed within articulating or telescoping components operably to an actuator mounted within the watercraft and operably coupled to apparatus system allowing an operator to control the actuator and selectively extend the flag.

The present invention has been developed in response to the present state of the art, and in particular, in response to the safety problems and needs in the art that have not yet been fully solved by currently available aparati. Accordingly, the present invention has been developed to provide an automated flag extension apparatus, the apparatus comprising: a foldable flag assembly affixed to a distal end of an articulable arm, the foldable flag assembly comprising: a plurality of slats hingedly affixed to pivot point, a flag coprising a plurality of slats, wherein the flag is operable to unfold into an open configuration with gravity and to be pushed back into a closed configuration; wherein the foldable flag assembly is operable to rotate into a concave recess of the articulable arm; a concave mounting bracket affixed to a surface of a hull of boat, the concave mounting bracket defining a hollow interior recess having an open top end, the concave recess operable to house the articulable arm and flag assembly in a close configuration; and an articulable arm hingedly affixed to a distal end of the mounting bracket.

The foldable flag assembly comprises a plurality of triangular sectors made of flexible polymeric material.

A second automated flag extension apparatus is provided, the apparatus comprising: a cylindrical tubular housing affixed to a mounting housing; the mounting housing compring a spoon wound with cable and a motor; a plurality of cylindrical telescoping members positions concentrically within one another, the plurality of cylindrical telescoping members define a hollow interior recess; a spring positioned within the hollow interior recess, biasing the telescoping members into an extended position; an end cap affixed to an innermost telescoping member against which the spring applies tensile force; where the cable is affixed to the end cap and operable to pull the end cap and telescoping members into a retracted postion;

The apparatus may further comprise a collapsible flag affixed to the end cap The end cap and innermost cylindrical telescoping member may be formed as a single integrated piece.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side perspective view of an automated flag extension apparatus in accordance with the present invention;

FIG. 2 is a rear perspective view of an automated flag extension apparatus in accordance with the present invention;

FIG. 3A is an environmental, side perspective view of an automated flag extension apparatus in accordance with the present invention;

FIG. 3B is an environmental, side perspective view of an automated flag extension apparatus in accordance with the present invention;

FIG. 4 is a side perspective view of an automated flag extension apparatus in accordance in a closed configuration with the present invention;

FIG. 5A is a side perspective view of an automated flag extension apparatus in accordance in an open configuration with the present invention;

FIG. 5B is a side perspective view of an automated flag extension apparatus in accordance in an open configuration with the present invention;

FIG. 5C is a side perspective view of an automated flag extension apparatus in accordance in an open configuration with the present invention;

FIG. 6 is a sectioned, side perspective view of an automated flag extension apparatus in accordance in a closed configuration with the present invention;

FIG. 7A is an environmental, side perspective view of an automated flag extension apparatus in accordance with the present invention;

FIG. 7B is an environmental, side perspective view of an automated flag extension apparatus in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to convey a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide an extendable warning flag automated to mechanically extend upon activation by a user, the warning flag affixed to a hull of boat as part of surf wake system. The system/appartus may include a flag housed within articulating or telescoping components operably to an actuator mounted within the watercraft and operably coupled to apparatus system allowing an operator to control the actuator and selectively extend the flag.

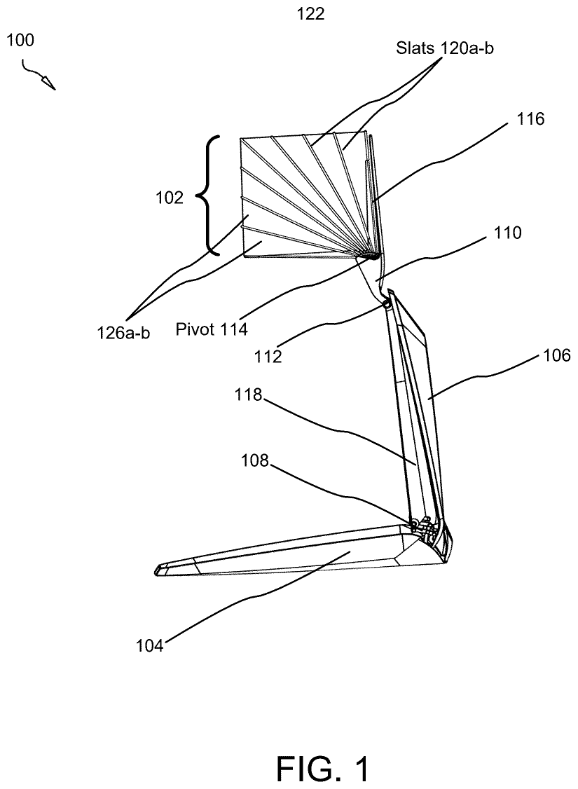

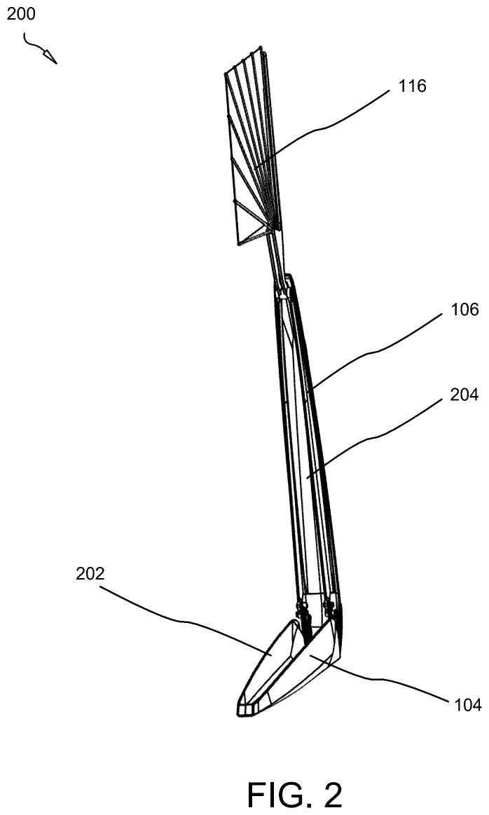

FIGS. 1-2 illustrate a side perspective view of an automated flag extension apparatus 100, 200 in accordance with the present invention.

In various embodiments, the automated flag extension apparatus 100 comprises a flag assembly 102 having a mounting arm 110 hingedly affixed to a distal end of an articulable arm 106. The articulable arm 106 may be concave and operable to receive (into a recess 204) the flag assembly 102 when the mounting arm 110 is rotated downwardly.

The flag assembly 102 may comprise a plurality of triangular sectors 126a-b disposed between slats 120a-b. The slats 120a-b may be affixed at a pivot point 114 and operable to unfold around the pivot point 114.

In various embodiments, the articulable arm 106 folds into an open top end and recess 202 defined by the concave mounting bracket 104. The flag assembly 102 folds closed into recess 204 defined by the articulable arms 106 before the articulable arm 106 folds closed.

The articulable arm 106 may be unfolded, or extended, using electromechanical means or hydraulic means. For instance, the extendable arm 106 may be extended using a jackscrew mechanism as known to those of skill in the art. The articulable arm is affixed at a proximal end to a distal end of the mounting bracket 104.

Likewise, the flag assembly 102 may extend using a jackscrew mechanism.

The apparatus 100 may integrate with a boat, ATV, dune buggy, or other recreational vehicle 302.

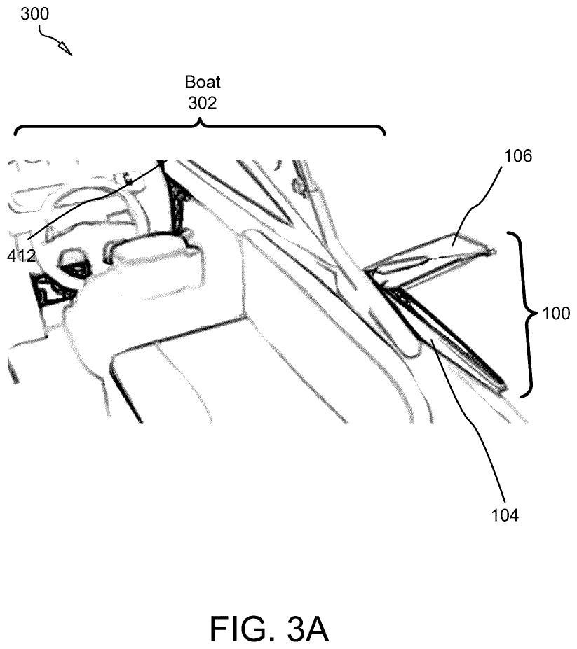

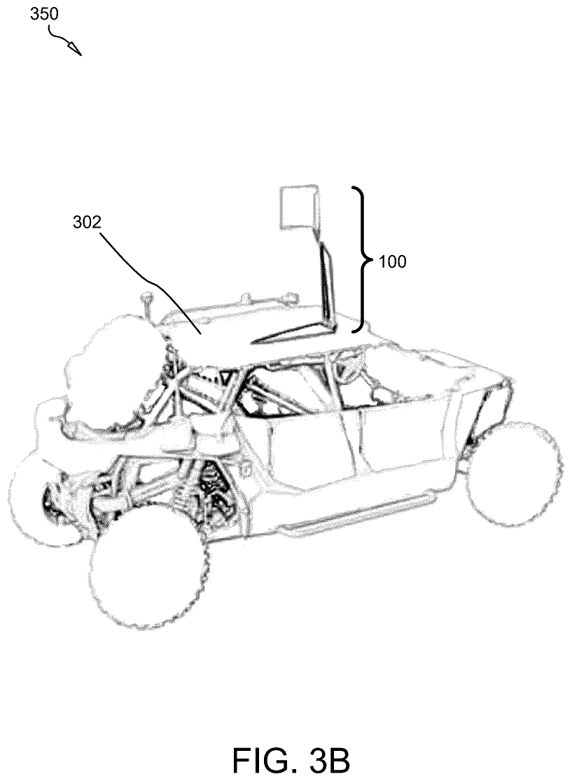

FIG. 3A is an environmental, side perspective view of an automated flag extension apparatus 300 in accordance with the present invention.

The flag assembly 100 may be affixed to hull of a boat 302 as shown and operator from a control switch interior to a recreational vehicle 302, which may comprise a boat, ATV, dune buggy, dirtbike, and the like.

FIG. 3B is an environmental, side perspective view of an automated flag extension apparatus in accordance with the present invention;

In some embodiments, the apparatus 100 positions, and is bolted in place, along an exterior surface of an ATV.

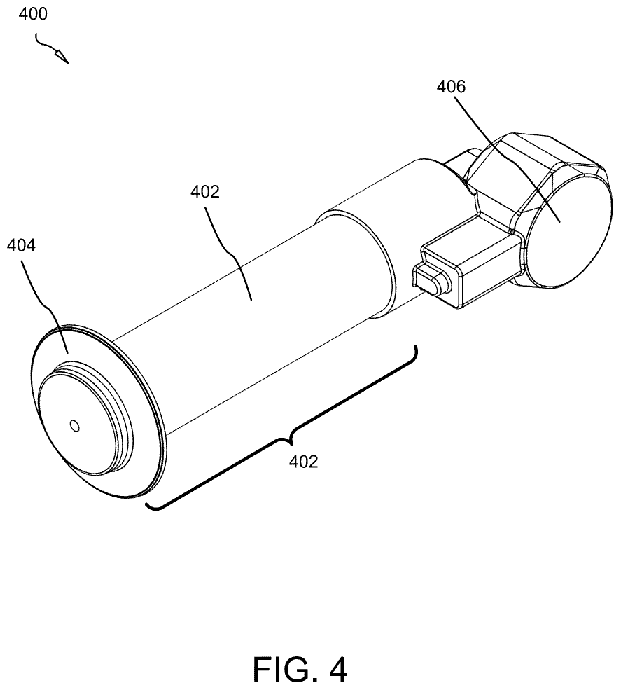

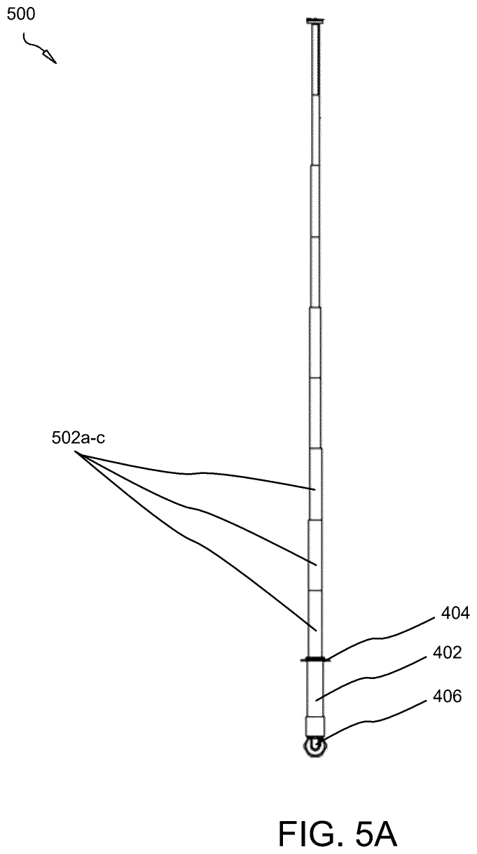

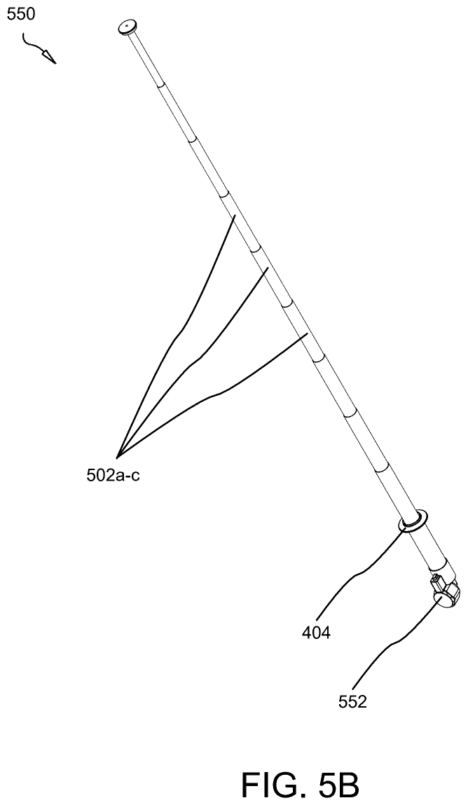

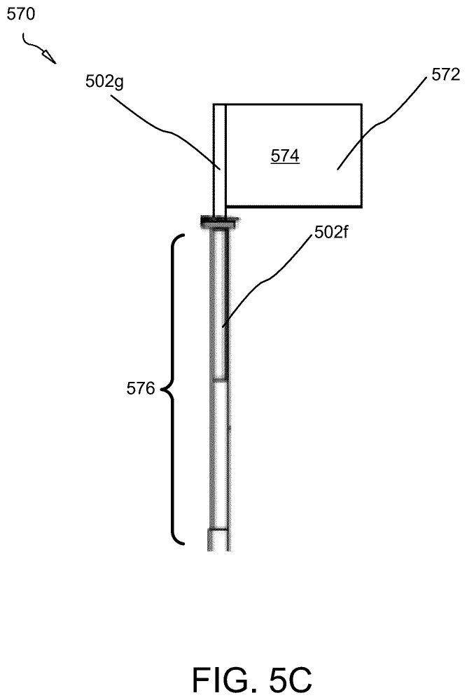

FIG. 4-5A illustrate a side perspective view of an automated flag extension apparatus 400, 500 in accordance in a closed configuration with the present invention.

In various embodiments, the flag assembly 400 comprises a cylindrical tubular housing 402 affixed to a mounting housing 406. The housing 406 is operable to be affixed to, or with, a hull of a boat or ATV 302.

A plurality of cylindrical, telescoping members 502 position concentrically within the cylindrical housing 402.

The cylindrical tubular housing 402 may be affixed to a flange 404, or may be formed as a single integrated piece with the flange 402.

A plurality of telescoping members 502a-c insert one into another and telescope outwardly to extend the flag assembly 572 upwardly. In some embodiments, the flag assembly 572 is affixed to a superior telescoping member 502g which pulls the flag inwardly into the recess 604.

A flag 574 may be affixed to a top cylindrical telescoping member 502, and may be pulled into the hollow interior recess 604 above the superior telescoping member 502.

FIG. 5B is a side perspective view of an automated flag extension apparatus in accordance in an open configuration with the present invention.

The telescoping members 502 are shown.

FIG. 5C is a side perspective view of an automated flag extension apparatus in accordance in an open configuration with the present invention.

The motor 552 is shown.

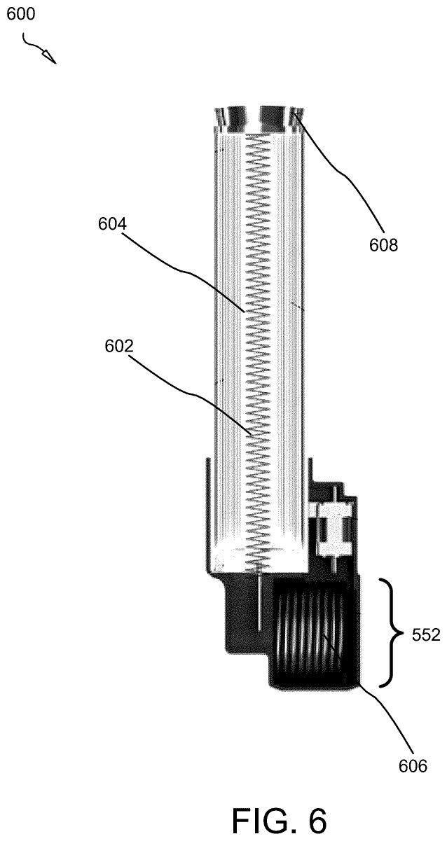

FIG. 6 is a sectioned, side perspective view of an automated flag extension apparatus 600 in accordance in a closed configuration with the present invention.

The apparatus 600 may define a hollow interior recess 604 in which a spring 602 positions.

In various embodiments, the apparatus 600 is spring-biased into an extended position by a spring 602. The spring 602 may apply tensile force against an end cap 608 affixed to a top telescoping member 502.

In various embodiments, a cable 606 is wound around a motor 552 within the housing 106. A distal end of the cable 606 traverses the hollow interior recess 604 and affixes to the end cap 608. The cable 606 is wound around a spool within the housing 106. The cable 606 is operable to retract the extended telescoping members (forming a boom) into a retracted position by pulling the telescoping members inwardly into against the spring 602.

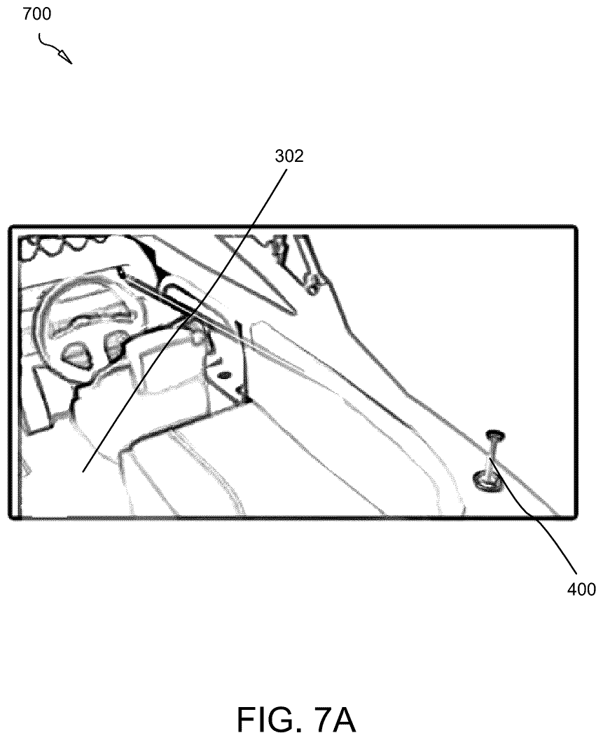

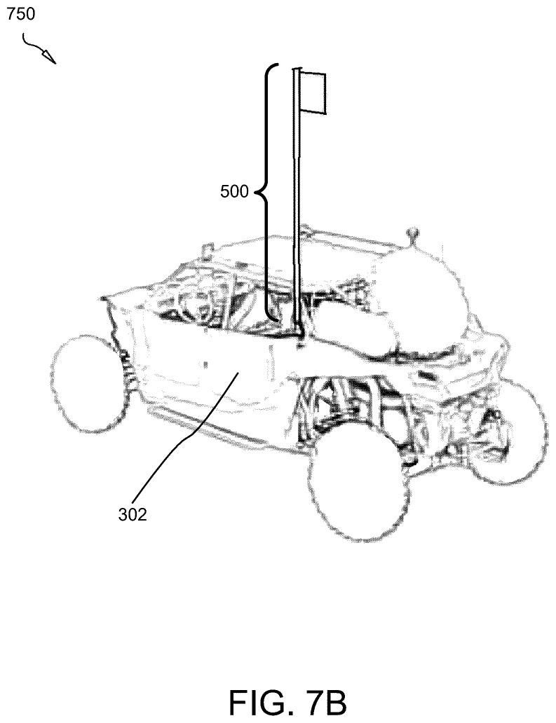

FIG. 7A is an environmental, side perspective view of an automated flag extension apparatus in accordance with the present invention;

In various embodiments, the apparatus 400 in mounted underneath a surface of a hull of a boat 302 as shown.

FIG. 7B is an environmental, side perspective view of an automated flag extension apparatus 750 in accordance with the present invention.

In various embodiments, the apparatus 750 positions underneath a rooftop covering of an ATV 302 as shown.

The invention may be emboded in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automated flag extension apparatus, the apparatus comprising:
a foldable flag assembly affixed to a distal end of an articulable arm, the foldable flag assembly comprising:
a plurality of slats hingedly affixed to pivot point,
a flag coprising a plurality of slats,
wherein the flag is operable to unfold into an open configuration with gravity and to be pushed back into a closed configuration;
wherein the foldable flag assembly is operable to rotate into a concave recess of the articulable arm;
a concave mounting bracket affixed to a surface of a hull of boat, the concave mounting bracket defining a hollow interior recess having an open top end, the concave recess operable to house the articulable arm and flag assembly in a close configuration; and
an articulable arm hingedly affixed to a distal end of the mounting bracket.

2. The apparatus of claim 1, wherein the foldable flag assembly comprises a plurality of triangular sectors made of flexible polymeric material.

3. An automated flag extension apparatus, the apparatus comprising:
a cylindrical tubular housing affixed to a mounting housing;
the mounting housing compring a spoon wound with cable and a motor;
a plurality of cylindrical telescoping members positions concentrically within one another, the plurality of cylindrical telescoping members define a hollow interior recess;
a spring positioned within the hollow interior recess, biasing the telescoping members into an extended position;
an end cap affixed to an innermost telescoping member against which the spring applies tensile force;
wherein the cable is affixed to the end cap and operable to pull the end cap and telescoping members into a retracted position.

4. The apparatus of claim 1, further comprising a collapsible flag affixed to the end cap.

5. The apparatus of claim 1, wherein the end cap and innermost cylindrical telescoping member are forming as a single integrated piece.
